(19) United States
(12) Patent Application Publication
(10) Pub. No.: US 2013/0116980 A1
(43) Pub. Date: May 9, 2013

(54) MODULAR MODELING AND DESIGN OF ANTENNAS AND RADIO FREQUENCY CIRCUITS THAT ARE ARRANGED IN A CLASS OF COMPOSITE STRUCTURAL CONFIGURATIONS

(71) Applicants: Nirod K. DAS, Ledgewood, NJ (US); Brian McCabe, Orange, CT (US)

(72) Inventors: Nirod K. DAS, Ledgewood, NJ (US); Brian McCabe, Orange, CT (US)

(21) Appl. No.: 13/539,856

(22) Filed: Jul. 2, 2012

Related U.S. Application Data
(60) Provisional application No. 61/504,006, filed on Jul. 1, 2011.

(51) Int. Cl. G06F 17/50

(52) U.S. Cl. CPC G06F 17/50
USPC 703/1

(57) ABSTRACT

The problem of modeling and designing a structure including a planar element(s) (e.g., antenna, RF circuit, etc.) arranged in association with a non-planar element(s) (e.g., non-planar packaging, a non-planar scattering element, a complex meta material, a periodic array element, etc.), in a computationally efficient and rigorous manner is solved by (1) modeling each of the planar elements using both conventional space-spectral analysis and complex space-spectral analysis to obtain an electro-magnetic (EM) signature matrix for each planar element, (2) determining (e.g., using a brute force modeling based on Maxwell's equations, by measuring experimentally, or by reading one from a stored library) an EM signature matrix (e.g., reflection and scattering matrices) compatible with those of the planar elements, for each of the non-planar elements, and (3) combining the EM signatures of the elements using matrix analysis to obtain a complete EM signature the structure.

### §1. RELATED APPLICATIONS

This application claims the benefit of U.S. Provisional Patent Application Ser. No. 61/504,006 (incorporated herein by reference and referred to as the “006 provisional”), filed on Jul. 1, 2011, titled “A NEW EFFICIENT AND VERSATILE COMPUTER TECHNIQUE FOR MODULAR MODELING AND DESIGN OF ANTENNAS AND RADIO-FREQUENCY CIRCUITS, THAT ARE ARRANGED IN A CLASS OF COMPOSITE STRUCTURAL CONFIGURATIONS ( . . . , INCLUDING PLANAR ELEMENTS EMBEDDED IN A GENERAL NON-PLANAR PACKAGING/SCATTERING ENVIRONMENT, A METAMATERIAL MEDIUM, OR A PERIODIC ARRAY ENVIRONMENT, ALLOWING FLEXIBLE REARRANGEMENT OR MODIFICATION OF PARTS OF DIFFERENT SHAPE, SIZE AND FUNCTIONALITY, AND INDEPENDENT HIERARCHICAL DESIGN OF EACH PART USING DIFFERENT TECHNIQUE OR ACCURACY)” and listing Nirod DAS as the inventor. The present invention is not limited to requirements of the particular embodiments described in the '006 provisional application.

### §2. BACKGROUND OF THE INVENTION

§2.1 Field of the Invention

The present invention concerns the modeling and design of devices that emit or receive electromagnetic (EM) radiation, such as antennas and radio-frequency (RF) circuits. More specifically, the present invention concerns systems and methods for modeling or designing such devices more efficiently.

§2.2 Background Information

Modern RF antennas and electromagnetic systems are often included as elements in composite structural arrangements including planar and non-planar elements, and different material and structural environments serving different functional roles. Designing such systems often requires computer simulation because simple text-book formulas are not adequate in such cases. Known computer simulators for RF antenna and EM system design include, for example, EEsof EDA from Agilent of Santa Clara, Calif., and HFSS Antenna Design Kit from ANSYS of Canonsburg, Pa.

Computer simulation using techniques and tools available today tend to model such composite structures using “brute-force” techniques. Although such techniques can be accurate and useful, their applications are limited by finite computer resources. Although the simulation of relatively small or medium sized systems can usually be implemented using such conventional methods, design rearrangement, or iterative optimization can be computationally expensive and/or prohibitively time-consuming. Modeling of (a) relatively large systems, and/or (b) systems that include elements of disproportionately different sizes covering micron to meter or miles in dimension are often not practical to simulate using such conventional methods. Furthermore, as opposed to simulating a given design for purposes of verification, such conventional methods are often found wanting when significant flexibility in design variations or iterative optimization are desired.

As should be appreciated from the foregoing, computer simulators for RF antenna and EM system design that mainly employ conventional “brute force” techniques have practical limitations. Consequently, new techniques and systems intrinsically adapted to the above situations are needed to address modern RF system and antenna system design needs.

### §3. SUMMARY OF THE INVENTION

The problem of modeling and designing a structure including (1) one or more planar elements (e.g., a planar antenna, a planar RF circuit, etc.) arranged in association with (2) one or more non-planar elements (e.g., a non-planar packaging, a non-planar scattering element, a complex meta material, a periodic array element, etc.), in a computationally efficient and rigorous manner, is solved by (1) modeling each of the one or more planar elements using both (i) conventional space-spectral analysis and (ii) complex space-spectral analysis to obtain an electro-magnetic (EM) signature matrix for each of the one or more planar elements, (2) determining (e.g., using a brute force modeling based on Maxwell's equations, by measuring experimentally, or by reading one from a stored library) an EM signature matrix (e.g., reflection and scattering matrices) compatible with those of the planar elements, for each of the one or more non-planar elements, and (3) combining the EM signatures of each of the one or more planar elements and the EM signatures of each of the one or more non-planar elements using matrix analysis to obtain a complete EM signature of the structure, from which any specific input/output characteristics of the system can be obtained as needed.

If any element is to be rearranged (e.g., repositioned and/or reoriented), the EM signature of the rearranged element can be transformed, and then recombined with the EM signatures of each of the other elements using matrix analysis to obtain an updated complete EM signature of the structure.

### §4. BRIEF DESCRIPTION OF THE DRAWINGS

FIGS. 1A and 1B are plan and side views, respectively, of a general radiating and/or closed conductor-backed structure including planar source element(s) and surrounding (laterally, or on top or bottom) external scattering structure(s).

FIG. 2 is a flow diagram of an example method for modeling or designing a structure including one or more planar elements (e.g., a planar antenna, a planar radio frequency circuit, etc.) arranged in association with one or more non-planar elements.

FIG. 3 is a flow diagram of an example method for modeling a non-radiating planar element to obtain an electromagnetic (EM) signature matrix.

FIG. 4 is a flow diagram of an example method for modeling a radiating planar element to obtain an electromagnetic (EM) signature matrix.

FIG. 5 illustrates a contour of integration, C, in the complex plane, in the case when all waves are “outgoing”, and that (C₀⁺) when only the fundamental wave component is “incoming” while all others are outgoing.

FIG. 6 illustrates a contour of integration, Cₘ⁺, in the complex plane, in the case when contribution from the m-th pole (representing the z-variation of the associated guided wave) is “incoming” while all others are outgoing.

FIG. 7 illustrates a contour of integration, C⁺, in the complex plane, in the case when all guided wave components are “incoming” in nature.

FIG. 8 depicts the geometry 800 of a planar element 810 placed inside a general meta-material environment 820, which may or may not be planar or periodic.

FIG. 9 depicts the geometry 900 of a periodic array of planar elements 910 placed inside a general periodic meta-material environment 920, which may or may not be planar.

FIG. 10 is a flow diagram of a method 1000 for electromagnetic modeling of a composite structure including planar and non-planar modules, in a meta-material or an array environment.

FIG. 11 is a block diagram of an exemplary apparatus 1100 that may perform various operations, and store various information generated and/or used by such operations, in a manner consistent with the present invention.

### §5. DETAILED DESCRIPTION

The present invention may involve novel methods, apparatus, message formats, and/or data structures for modeling and design of devices that emit or receive electro-magnetic (EM) radiation, such as antennas and radio-frequency (RF) circuits. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventor regards his invention as any patentable subject matter described.

### §5.1 INTRODUCTION

Modeling electrical or electromagnetic systems includes solving radiation and wave interaction using electromagnetic theory. As discussed above, general brute-force solutions (e.g., using Maxwells' equations) can become so computationally complex and expensive, that they are of limited practical (or no) use when it is desired to incorporate design rearrangements or incremental iterative design changes.

Planar waves in simple uniform or layered media are the most basic and simple solutions for electromagnetic phenomena. Such simple solutions are applicable to problems that are “strictly planar” in geometry, and which can be implemented using a plane-wave or spectral synthesis technique. (See, e.g., the references: T. Itoh, “Spectral Domain Immitance Approach for Dispersion Characteristics of Generalized Printed Transmission Lines”, IEEE Transactions on Microwave Theory and Techniques, Vol. 28, No. 7, pp. 733-736 (July, 1980), incorporated by reference; C. M. Krowne, “Green's Function in the Spectral Domain for Biaxial and Uniaxial Anisotropic Planar Dielectric Structures,” IEEE Transactions on Antennas and Propagation, Vol. 32, No. 12, pp. 1273-1281 (December, 1984), incorporated herein by reference; C. M. Krowne, “Numerical Spectral Matrix Method for Propagation in General Layered Media: Application to Isotropic and Anisotropic Substrates”, IEEE Transactions on Microwave Theory and Techniques, Vol. 35, No. 12, pp. 1399-1407 (December, 1987), incorporated herein by reference; and N. K. Das and D. M. Pozar, “A Generalized Spectral-Domain Green's Function for Multilayer Dielectric Substrates with Applications to Multilayer Transmission Lines,” IEEE Transactions on Microwave Theory and Techniques, Vol. 35, No. 3, pp. 326-335 (March, 1987), incorporated herein by reference.) Similar spectral synthesis models may also be extended to layered structures on cylindrical surfaces. (See, e.g., the reference, K. E. Golden and G. E. Stewart, “Self and Mutual Admittance for Axial Rectangular Slots on a Cylinder in the Presence of an Inhomogeneous Plasma Layer,” IEEE Transactions on Antennas and Propagation, Vol. 19, No. 2, pp. 296-299 (March, 1971), incorporated herein by reference.) Unfortunately, such simple and efficient planar models currently available are not applicable to structures that include general non-planar structures or a meta-material environment.

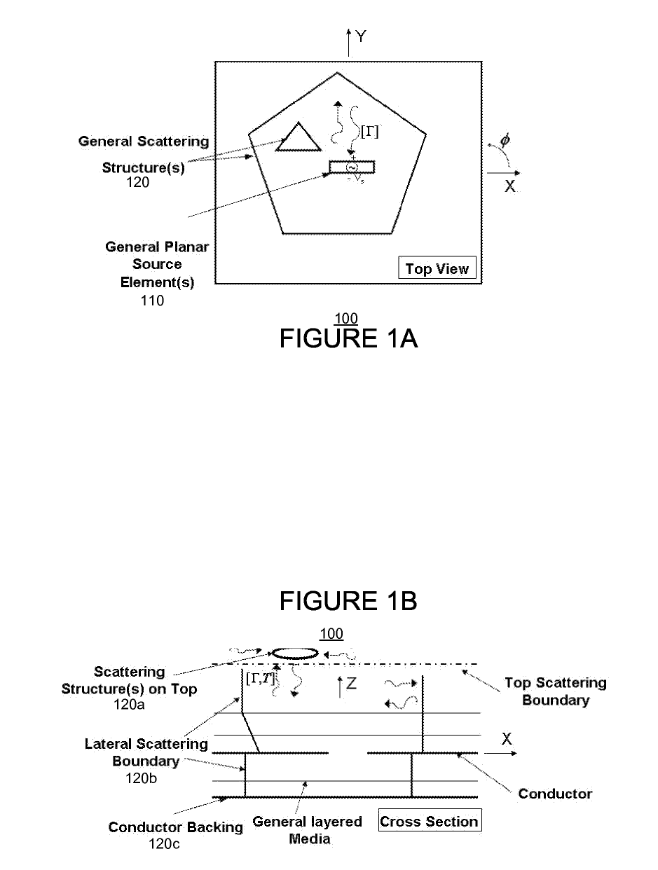

However, a sufficiently small portion of the total structure may be treated as a “locally planar” element, which is enclosed with a general material medium or non-planar surrounding. A basic configuration of a locally-planar source element, enclosed by a general material or non-planar surrounding, is shown in FIGS. 1A (plan view) and 1B (cross-sectional side view). More specifically, FIGS. 1A and 1B are plan and side views, respectively, of a general radiating and/or closed conductor-backed structure 100 including planar source element(s) 110 and surrounding (laterally, or on top or bottom) external scattering structure(s) 120. A more general large structure may include more than one planar source element or module of closely-spaced elements.

Each planar element or module may be efficiently modeled using a planar solution, which may assume that the external medium beyond the planar region is an ideal continuation of the local medium to infinite distances. A suitable electromagnetic signature for each module may be extracted from the individual planar models, without much additional computational burden, which accounts for any general interactions with its surrounding. A process to extract the electromagnetic signatures and to use them to model any general interaction between the modules, or with a general surrounding, is described. Other non-planar source or scattering elements of the total structure, which can not be modeled as a locally planar structure, may be modeled by using a brute-force conventional technique, or may be measured experimentally. For example, the EM signatures may be measured experimentally if computer modeling is difficult, or if the internal structure of a part is inaccessible for evaluation. In this way, brute-force techniques may be applied only as needed, thereby minimizing such computationally expensive techniques. In additional, such “brute force” computation (or experimental measurements) only need to be performed once in order to extract a suitable EM signature of such (small) non-planar parts. Indeed, the individual planar and/or non-planar elements may have distinct functional roles, and they may be designed and modeled independently (e.g., on different occasions, possibly even using different modeling tools). The independent elemental (or modular) data can be saved and reused for future simulation of a larger structure which uses the design elements. That is EM signatures of various elements and or modules can be stored (e.g., in a computer-readable library of EM signatures) for reuse later.

The following describes a new theory (based on a simple planar modeling framework), as well as an associated computer-implemented process, to combine general interactions between neighboring elements and their surrounding environment. External interactions are incorporated by including incoming waves in the planar modeling. Incoming waves may, in general, be incident from above, from below, and/or from lateral sides of the source.

The following also describes a new theory, as well as an associated computer-implemented process, to define and extract a complete electromagnetic signature for a planar source module, a non-planar scattering environment, or a meta-material medium. The EM signatures may be expressed in terms of planar, cylindrical, and/or spherical waves propagating in the lateral, and/or normal directions. These new theories, and their associated computer-implemented processes, serve complementary roles, and may be used together as a computer-aided design tool.

### §5.2 EXAMPLE METHODS

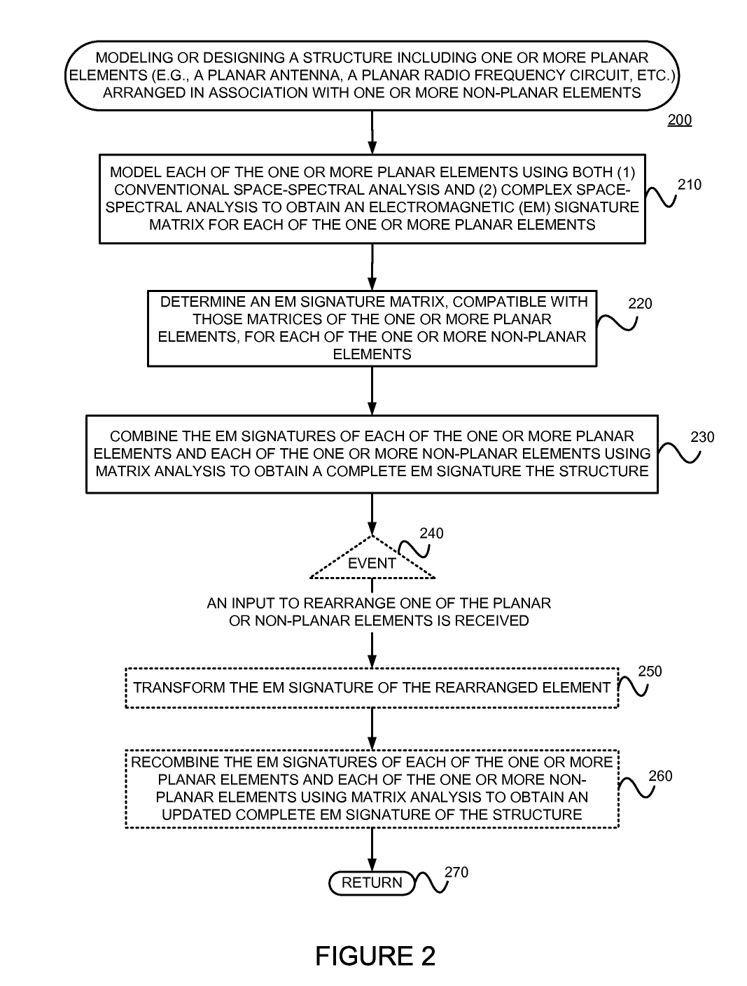

FIG. 2 is a flow diagram of an example method 200 for modeling or designing a structure including one or more planar elements (e.g., a planar antenna, a planar radio frequency circuit, etc.) arranged in association with one or more non-planar elements. As shown, each of the one or more planar elements are modeled using both (i) conventional space-spectral analysis and (ii) complex space-spectral analysis, to obtain an electromagnetic (EM) signature matrix for each of the one or more planar elements. (Block 210) Further, an EM signature matrix, compatible with those matrices of the one or more planar elements, is determined for each of the one or more non-planar elements. (Block 220) Finally, the EM signatures of each of the one or more planar elements and each of the one or more non-planar elements are combined using matrix analysis to obtain a complete EM signature the structure. (Block 230) The method 200 may be left at this point. (Node 270) However, recall that it may be desired to permit design alterations and modifications. In such example embodiments, the method 200 may perform further acts in response to the receipt of an (e.g., user) input to rearrange (e.g., reposition and/or reorient) one of the planar or non-planar elements. (Event 240) If such an input is received, the method 200 may further transform the EM signature of the rearranged element (Block 250), and recombine the EM signatures of each of the one or more planar elements and each of the one or more non-planar elements using matrix analysis to obtain an updated complete EM signature of the structure (Block 260) before the method 200 is left (Node 270).

In the example method 200 of FIG. 2, each of the EM signature matrices may be expressed in terms of (A) planar, (B) cylindrical and/or (C) spherical waves, propagating in lateral and/or normal directions.

Referring back to block 210 of FIG. 2, in some example embodiments, the act of modeling each of the one or more planar elements using conventional space-spectral analysis to obtain an electro-magnetic (EM) signature matrix for each of the one or more planar elements includes using a moment model implemented in the spatial Fourier domain, and a complex-Fourier plane treatment of the moment model to extract EM signature information.

Referring back to block 220 of FIG. 2, in some example embodiments, the act of determining an EM signature matrix for at least one of the one or more non-planar elements may use a brute force modeling based on Maxwell's equations, and extract an EM signature matrix, compatible with the EM signature matrices of the one or more planar elements, from the brute-force model. Alternatively, or in addition, such an act may use experimentally measured parameters. Alternatively, or in addition, such an act may include reading a previously determined EM signature matrix from a library of EM signature matrices stored on a non-transistory storage medium.

Still referring to block 220 of FIG. 2, in some example embodiments, the EM signature matrix for each of the one or more non-planar elements includes (A) reflection characteristics and/or (B) scattering or transmission characteristics.

Still referring to block 220 of FIG. 2, in some example embodiments in which a non-planar element is (A) a non-planar packaging, (B) a non-planar scattering element, (C) a complex meta material, or (D) a periodic array element, the act of determining an EM signature matrix for such a non-planar element may include modeling “locally planar” portions of the one non-planar element using both (i) the conventional space-spectral analysis and (ii) the complex space-spectral analysis.

Referring back to 230 of FIG. 2, in some example embodiments, the act of combining the EM signatures of each of the one or more planar elements and each of the one or more non-planar elements using matrix analysis to obtain a complete EM signature of the structure includes using mathematical contour deformation techniques on a complex Fourier plane.

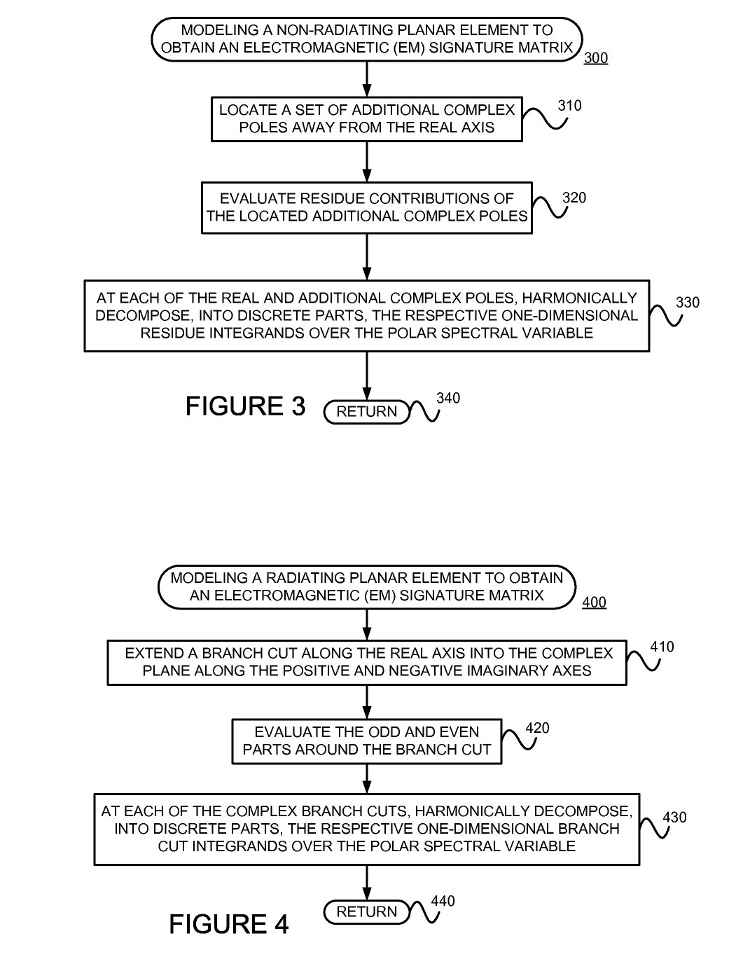

Referring back to block 210 of FIG. 2, FIG. 3 is a flow diagram of an example method 300 for modeling a non-radiating planar element to obtain an electromagnetic (EM) signature matrix. As shown, the example method 300 includes locating a set of additional complex poles away from the real axis (Block 310), evaluating residue contributions of the located additional complex poles (Block 320), and, at each of the real and additional complex poles, harmonically decomposing, into discrete parts, the respective one-dimensional residue integrands over the polar spectral variable (Block 330).

Still referring back to block 210 of FIG. 2, FIG. 4 is a flow diagram of an example method 400 for modeling a radiating planar element to obtain an electromagnetic (EM) signature matrix. As shown, the example method 400 includes extending a branch cut along the real axis into the complex plane along the positive and negative imaginary axes (Block 410), evaluating the odd and even parts around the branch cut (Block 420), and, at each of the complex branch cuts, harmonically decomposing, into discrete parts, the respective one-dimensional branch cut integrands over the polar spectral variable (Block 430).

§5.2.1 Refinements, Extensions and Alternatives

The example methods described above are based on a new theory, established in the complex space-spectral domain. Contour deformation techniques on a complex plane are useful for simplification of radiation integrals. (See, e.g., the reference, L. B. Felsen and N. Marcuvitz, Radiation and Scattering of Waves, Chapter 4 (Prentice Hall, 1973), incorporated herein by reference.) The example methods incorporate a suitable mixture of both “incoming” as well as “outgoing” cylindrical or planar waves, by using a non-conventional contour deformation on the complex plane. (Recall, e.g., block 210 of FIG. 2.)

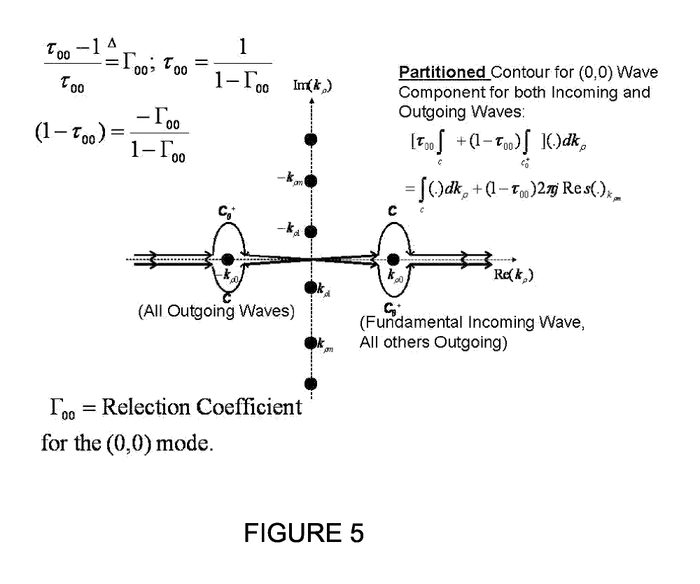

Different types of contours used to model specific conditions of wave propagation are shown in FIGS. 5-7. This is in contrast to only outgoing waves, normally included in a conventional spectral-domain treatment of planar structures. (See, e.g., the references: D. M. Pozar, “Input Impedance and Mutual Coupling of Rectangular Microstrip Antennas,” IEEE Transactions on Antennas and Propagation, Vol. 30, No. 6, pp. 1991-1996 (November, 1982), incorporated herein by reference; and N. K. Das and D. M. Pozar, “Multiport Scattering Analysis of Multilayered Printed Antennas Fed by Multiple Feed Ports, Part I: Theory; Part II: Applications,” IEEE Transactions on Antennas and Propagation, Vol. 40, No. 5, pp. 469-491 (May, 1992), incorporated herein by reference.) The contour-deformation analysis allows arbitrary incoming waves, defined in terms of a scattering or reflection matrix, to be coupled with the central source element, without added computational efforts. Similar non-conventional contour deformation was used for modeling leaky-wave phenomena, involving exponentially growing fields. (See, e.g., the references: N. K. Das and D. M. Pozar, “Full-Wave Spectral-Domain Computation of Material, Radiation and Guided Wave Losses in Infinite Multilayered Printed Transmission Lines,” IEEE Transactions on Microwave Theory and Techniques, Vol. 39, No. 1, pp. 54-63 (January, 1991), incorporated herein by reference; and D. Nghiem, J. T. Williams and D. R. Jackson, “Leakage of the Dominant Mode on Stripline with a Small Air Gap,” IEEE Transactions on Microwave Theory and Techniques, Vol. 43, No. 11, pp. 2549-2556 (November, 1995), incorporated herein by reference.) Here, for the first time, such contour-deformation calculus is used to treat another class of basic problems involving “incoming waves” from external scatterers. The following analysis is formulated for a non-radiating structure with a covering conducting wall on top and bottom layer of the structure, or for a radiating structure with an open free-space medium and non-planar scatterers above or below the planar source structure. (Recall, e.g., FIG. 1.)

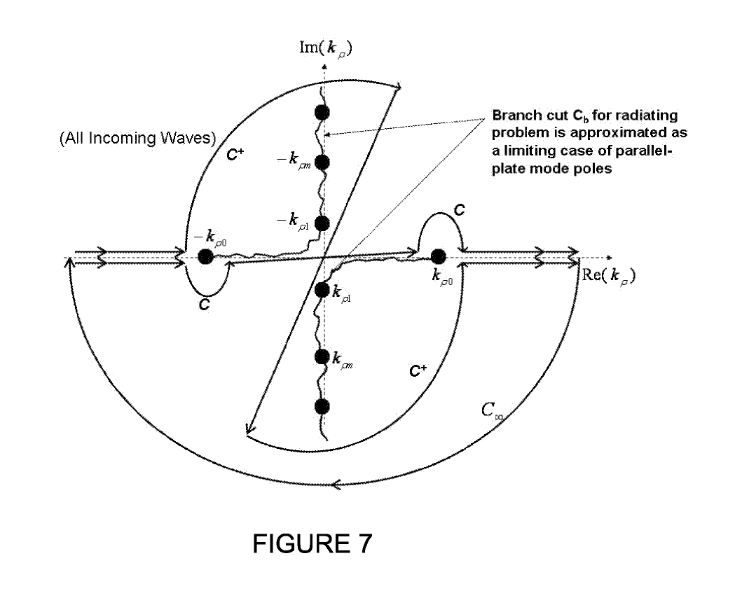

Referring to FIGS. 3, 5 and 6, the non-radiating problem encounters singularities in the complex wave-number plane. On the other hand, referring to FIGS. 4 and 7, the radiating problem encounters branch-cuts and branch planes on the complex spectral plane. However, a branch may analytically viewed as a limiting case of a sequence of closely spaced singularities. This is physically equivalent to having the top and bottom conducting walls of a non-radiating parallel-plate medium placed sufficiently far from the central structure. The principal and residue parts for the limiting non-radiating problem with singularities can be shown to be equivalent to “even” and “odd” parts of the function evaluated on the two sides of a branch cut in the equivalent non-radiating problem.

In the non-radiating case, the example method may perform numerical calculation of the precise locations of the poles and their associated residues. However, this can be time consuming and potentially inaccurate, particularly when a large number of singularities are included. In contrast, such tedious calculations can be avoided in the equivalent limiting radiating case, thereby providing a more powerful process that is computationally accurate and less burdensome. The equivalent treatment of branch cuts and singularities makes the technique more general and powerful (applicable to a large class of radiating, as well as non-radiating, structures, in the presence of general scattering or material environment, placed laterally to, above and/or below the source element).

FIG. 5 illustrates a contour of integration, C, in the complex plane, in the case when all waves are “outgoing”, and that (C₀⁺) when only the fundamental wave component is “incoming” while all others are outgoing. The first subscript index refers to a particular pole location which represents the z-variation of a cylindrical guided mode excited by the structure, whereas the second index refers to the angular harmonic decomposition which represents the azimuth variation of the particular cylindrical guided mode.

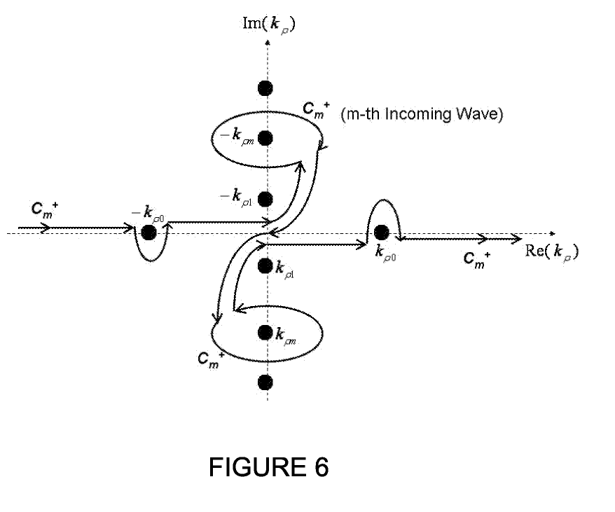

FIG. 6 illustrates a contour of integration, Cₘ⁺, in the complex plane, in the case when contribution from the m-th pole (representing the z-variation of the associated guided wave) is “incoming” while all others are outgoing.

FIG. 7 illustrates a contour of integration, C⁺, in the complex plane, in the case when all guided wave components are “incoming” in nature. Radiating problems that are open to free-space on top (or bottom), which may also include non-planar scattering structures, can be modeled using branch cuts, which can be approximated as closely spaced singularities. Effectively, the radiation to a free-space medium on top or bottom of the structure can be modeled as a superposition of guided waves in the lateral directions.

The example methods may consider the external structure or material environment to be general in nature, for which a complete “scattering signature” is assumed to be defined and available. For simple scattering structures, such as a rectangular or cylindrical metallic packaging or cavity-backing structure, or a cylindrical dielectric cavity coupled to the planar slot element, a complete scattering matrix may be derived in purely analytical form. More complex scattering is introduced when the environment is of arbitrary geometry and/or material distribution.

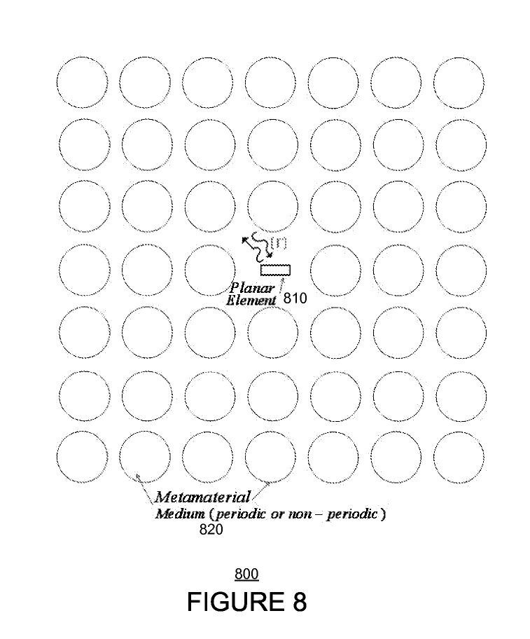

For example, the environment may include an arbitrarily-shaped packaging enclosure with metal shorting posts around the source module. In such a case, the scattering matrix may have to be derived using a more involved process one time, the results of which may be reused for modeling general source configurations placed in any relative position or orientation with respect to the particular packaging structure. A meta-material environment synthesized using different orientations or distributions of dielectric or metal elements may be treated as a scattering environment for an embedded source. For example, FIG. 8 depicts the geometry 800 of a planar element 810 placed inside a general meta-material environment 820, which may or may not be planar or periodic. The example method 200 can model such structures 800 like an isolated planar element with incoming and outgoing waves. Computation for the meta-material environment 820 does not have to be repeated for any modification or repositioning of the planar element(s) 810 in a given local planar region of the same meta-material medium 820. That is, such meta-material structures can also be modeled using the same general technique, by pre-computing suitable scattering parameters for a specific meta-material medium for once, and then reusing them for any general source configuration.

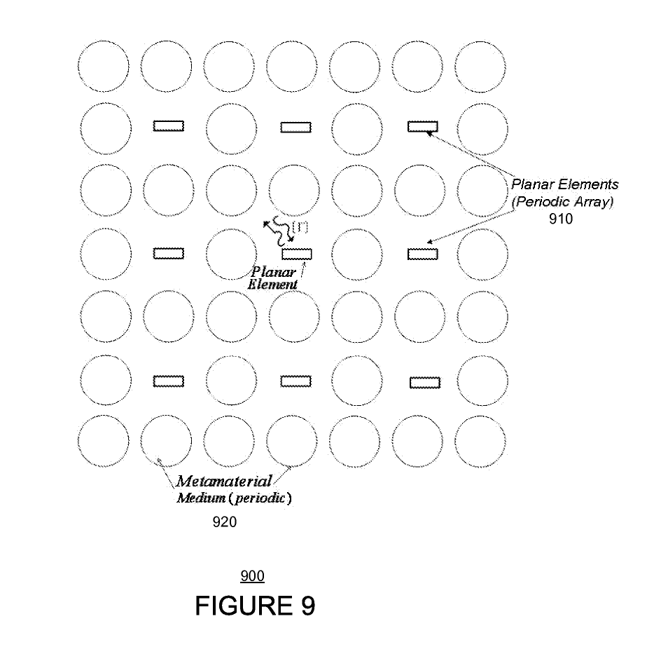

A periodic array of elements either with a periodic meta-material environment (See, e.g., FIG. 9.), or simply with a conventional planar material medium, may also be seen as a single element with incoming waves scattered from the surrounding array structure. For example, FIG. 9 depicts the geometry 900 of a periodic array of planar elements 910 placed inside a general periodic meta-material environment 920, which may or may not be planar. The example method 200 can model such array structures 900 like an isolated planar element by including both incoming and outgoing waves. Computation for the meta-material environment does not have to be repeated for any modification or repositioning of the periodic planar element(s) inside a local planar region of each unit cell of the same periodic meta-material medium. As a simple specific case, the periodic array of planar elements 910 in a planar environment can also be similarly modeled as a single element, by adding incoming fields from the entire array structure. For a given periodic arrangement, the computation of the array effects need not be repeated for a new element configuration, or different reorientations of the same element in the unit cell. More generally, in the case of a periodic array of elements either with a periodic meta-material environment such as in FIG. 9, or simply with a conventional planar material medium, the “scattering” signals (referred to as “active scattering” signals) would be different from scattering from a regular passive scattering structure. More specifically, they include incoming signals radiated from the other periodic source elements that are dependent on the relative phasing (or equivalent scan angles for a phased-array antenna) of the elements. The proposed general modeling technique is applicable to the array structures of FIG. 9 as well, which can be implemented by employing an equivalent “active scattering matrix” seen at any one of the source elements (which is same for any other element due to periodicity).

Using a suitable modeling and extraction technique, the scattering matrix may be pre-computed on a one-time basis, for a discrete set of phase distributions (or equivalent scan angles for a phased-array antenna), and the results can then be reused as in other general problems for different source configurations or repositioning. Clearly, the scope of the proposed computation technique covers a quite a large class of physical structures of significance in modern practical applications.

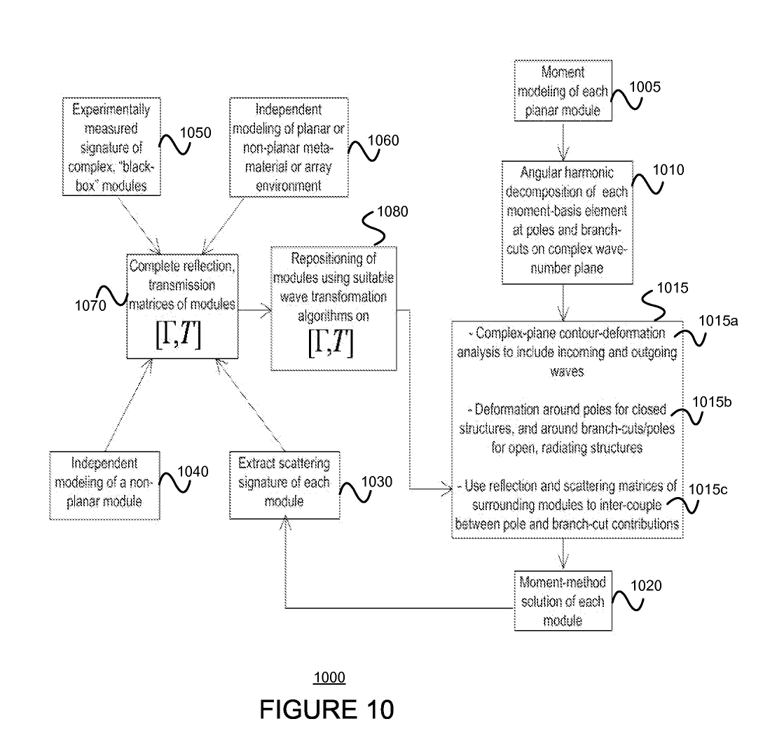

FIG. 10 is a diagram of an iterative method 1000 for electromagnetic modeling of a composite structure including planar (Block 1005) and non-planar (Block 1040 or 1050) modules, in a meta-material or an array environment (Block 1060). The example method 1000 is based on a general moment-method procedure (Block 1020), implemented in the Fourier domain. Such a general procedure is well known (See, e.g., the references: D. M. Pozar, “Input Impedance and Mutual Coupling of Rectangular Microstrip Antennas,” IEEE Transactions on Antennas and Propagation, Vol. 30, No. 6, pp. 1991-1996 (November, 1982), incorporated herein by reference; and N. K. Das and D. M. Pozar, “Multiport Scattering Analysis of Multilayered Printed Antennas Fed by Multiple Feed Ports, Part I: Theory; Part II: Applications,” IEEE Transactions on Antennas and Propagation, Vol. 40, No. 5, pp. 469-491 (May, 1992), incorporated herein by reference.), and is therefore not elaborated here.

The computation of the self or mutual admittance between two basis elements in a moment-method procedure, in the presence of a non-planar scattering environment, is described. Once such admittances are computed in an efficient manner using the example methods, together with a conventional moment-method procedure, the new technique provides a complete solution to the EM characteristic of the composite arrangement.

More specifically, the admittance of the planar structure, without any non-planar scattering environment, is modeled using a conventional space-spectral analysis. (Recall, e.g., the references: D. M. Pozar, “Input Impedance and Mutual Coupling of Rectangular Microstrip Antennas,” IEEE Transactions on Antennas and Propagation, Vol. 30, No. 6, pp. 1991-1996 (November, 1982), incorporated herein by reference; and N. K. Das and D. M. Pozar, “Multiport Scattering Analysis of Multilayered Printed Antennas Fed by Multiple Feed Ports, Part I: Theory; Part II: Applications,” IEEE Transactions on Antennas and Propagation, Vol. 40, No. 5, pp. 469-491 (May, 1992), incorporated herein by reference.) This includes computing coupling integrals along the real spectral axis (principal integral) and residue contributions around pole locations associated with the parallel-plate modes. (Block 1010) As implemented in a conventional procedure, all poles only on or near the real spectral axis are located and the respective residues are evaluated. However, as discussed above with reference to block 210 of FIG. 2, complex-space spectral analysis is used in addition. (Block 1015)

Regarding the complex-space spectral analysis, recall from the example method 300 of FIG. 3, that for a non-radiating problem, the example method also locates a set of additional complex poles away from the real axis (along the imaginary axis, for a loss-less parallel-plate structure) (Recall, e.g., 310 of FIG. 3.) and also evaluates their residue contributions (Recall, e.g., 320 of FIG. 3.). (1015a and 1015b) Recall also from the example method 400 of FIG. 4, that for a radiating problem, on the other hand, the branch cut along the real axis is extended into the complex plane along the positive and negative imaginary axes (Recall, e.g., 410 of FIG. 4.), and the “even” and “odd” parts are evaluated around the branch cut (Recall, e.g., 420 of FIG. 4.). (1015a and 1015b) Further, at each of the real as well as the additional complex poles, or the complex branch cut, the respective one-dimensional residue integrands or branch-cut integrands over the polar spectral variable are harmonically decomposed into discrete parts. (Recall, e.g., 330 of FIGS. 3 and 430 of FIG. 4.) This is like a Fourier-series decomposition, and can be implemented using a simple one-dimensional Fast Fourier Transform (FFT) procedure. Suitable upper limits for the guided mode indices or branch-cut are set to achieve numerical convergence and desired accuracy, requiring minimal computation.

Next, the Fourier decomposition parameters are combined together with a suitable scattering matrix for the given surrounding structure or material environment, and the admittance of the planar structure without any scattering environment, to calculate the new admittance including the scattering. (See 1015c of FIG. 10.) This process may be considered the final phase for processing the different computed parameters, using simple relations that are not computationally involved.

Any rearrangement (position or orientation) of the source and the scattering or material structure is implemented by properly transforming the Fourier decomposition parts of the source, or equivalently by similar transformation of the angular harmonic parts of the scattering parameters. (Optional block 1080) The position or orientation transformation is possible using only analytical formulas, which are computationally simple to evaluate. When there are multiple scatterers or material modules, then interactions between them with relative repositioning with respect to each other and/or the source are similarly manipulated by transformation of the individual scattering matrices. When there are multiple source blocks or modules, then interactions between them and with the scattering environment are also similarly handled through their scattering matrices and proper transformation. In case of scattering structures laterally positioned with respect to the source, only a reflection matrix that relates the incident and reflected lateral waves is needed. However, for scatterers positioned above (or below) the source (Recall, e.g., FIG. 1.), a scattering matrix that relates waves from both the source region below (or above) and waves from the lateral directions are needed. For a planar module or a scattering element that include internal excitation source(s), a more complete scattering matrix, including additional transmission parameters that represent coupling to the excitation source(s) from the outside incident waves, is needed.

Further details that may be used in example embodiments are described in the references: McCabe, B. L. and Das, N. K., “Part I: A New Theory for Modeling Conductor-Backed Planar Slot Antenna Elements, in the Presence of a General Non-Planar Surrounding,” IEEE Transactions on Antennas and Propagation, Volume 59, Issue 9, pp. 3171-3184 (September 2011 issue published on Jul. 14, 2011), incorporated herein by reference; and McCabe, B. L. and Das, N. K., “Part II: A Conductor-Backed Slot Antenna Element Surrounded by a Shorting-Post Cavity to Suppress Parallel-Plate Mode Excitation—Design Analysis and Experiment,” IEEE Transactions on Antennas and Propagation, Volume 59, Issue 9, pp. 3185-3193 (September 2011 issue published on Jul. 14, 2011), incorporated herein by reference.

### §5.3 EXAMPLE APPARATUS

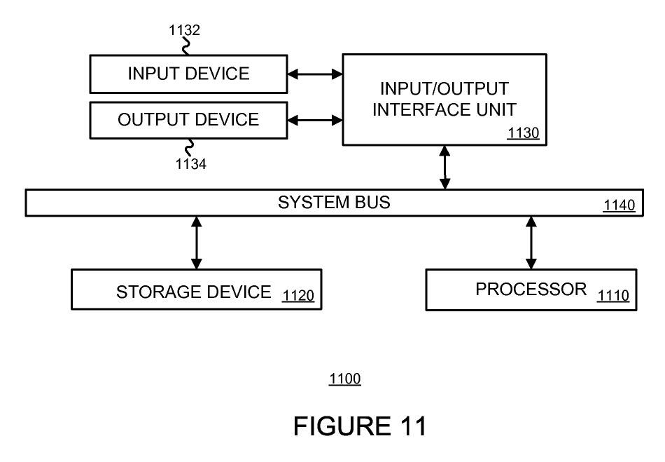

FIG. 11 is a block diagram of an exemplary apparatus 1100 that may perform various acts or methods, and store various information (e.g., a library of EM signature matrices) generated and/or used by such acts or methods, in a manner consistent with the present invention. The apparatus 1100 may include one or more processors 1110, one or more input/output interface units 1130, one or more storage devices 1120, and one or more system buses and/or networks 1140 for facilitating the communication of information among the coupled elements. One or more input devices 1132 and one or more output devices 1134 may be coupled with the one or more input/output interfaces 1130.

The one or more processors 1110 may execute machine-executable instructions (e.g., C or C++, Java, etc., running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 1120 and/or may be received from an external source via one or more input interface units 1130.

In one embodiment, the apparatus 1100 may be one or more conventional personal computers. In this case, the processing units 1110 may be one or more microprocessors. The bus 1140 may include a system bus. The storage devices 1120 may include system memory, such as read only memory (ROM) and/or random access memory (RAM). The storage devices 1120 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, and solid state storage.

A user may enter commands and information into the personal computer through input devices 1132, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1110 through an appropriate interface 1130 coupled to the system bus 1140. The output devices 1134 may include a monitor or other type of display device, which may also be connected to the system bus 1140 via an appropriate interface. In addition to (or instead of) the monitor, the personal computer may include other output devices (not shown), such as speakers and printers for example.

The various methods and acts described above may be performed by one or more apparatus 1100, and the various information described above may be stored on one or more apparatus 1100. Thus, the modeling and design methods described above may be implemented as processor-executable instructions (for example as software modules) stored on a non-transitory storage device (RAM, ROM, magnetic and/or optical disk storage, solid state storage, etc.). These instructions may be executed by one or more processors (for example, microprocessors). Data and/or instructions used may be received by one or more inputs via one or more input interfaces. Data produced may be output by one or more outputs via one or more output interfaces. Therefore, one or more aspects of the methods described above may be implemented on a personal computer, a laptop computer, a personal digital assistant, a server, a smart communications device, etc. Alternatively, or in addition, one or more aspects of the methods described above may be implemented on hardware (for example, integrated circuits, application specific integrated circuits, programmable logic or gate arrays, etc.).

### §5.4 CONCLUSIONS

New computer-based processes for analyzing and designing radio-frequency circuits and antennas have been described. The computational framework and methods allow planar antennas or circuit elements, surrounded by a general non-planar packaging or scattering structure, or operating in a complex meta-material or a periodic array environment, to be efficiently modeled and designed. New computational features, not otherwise available using conventional numerical techniques and computational tools available today, are supported. For example, planar elements embedded in different environments can be rigorously modeled in an efficient manner together, with the computational simplicity of a fully planar structure. As a second example new feature, parts of the structure, such as (1) a source antenna or circuit element and (2) a metamaterial medium or a packaging and/or scattering structure, may be independently modeled using different computer techniques or accuracies, after which the results can be rigorously combined for the design of a complex, composite structure. As a third example new feature, repositioning or reorientation of elements can be handled with minimal re-computation (i.e., without having to model the entire structure again). As a fourth example feature, an electromagnetic radiation or scattering signature of one or more elements may be determined by an experimental measurement, and the results can be rigorously combined in the field analysis and design of the composite structure (including the one or more elements) with the above different variations. As a fifth example feature, significant computational efficiency and flexibility facilitates the implementation of novel design strategies, and complex design optimization or “real-time” simulations. As a sixth example feature, complex structures involving parts or subparts of diverse physical sizes from micron and nano-meter to meter and miles can be modeled and designed with optimal accuracy for each part. Thus, the foregoing methods provide a new paradigm in electromagnetic simulation and computer-aided design for a general class of locally planar or layered structures, embedded in a general meta-material and scattering environment.

The new processes exploit the concept of synthesizing electromagnetic fields using planar waves, which are the simplest form of waves to model and compute. Radiation and scattering from planar structures are directly compatible to such efficient plane-wave modeling. General structures, involving complex material media or structural environment which may not be planar in nature, may be conventionally modeled using “brute-force” computational methods, or determined experimentally. Although such brute-force techniques are, in principle, applicable to any general configurations, they are inherently complicated and therefore are often impractical for use in general applications. This is because beyond a certain level of structural or material complexity, the brute-force computational approaches become prohibitively time consuming and impractical to use. However, by employing suitable mathematical synthesis techniques, the example methods may treat complex interactions from a general surrounding environment in terms of “locally planar” waves, which are valid in a locally planar region external to the physical structure.

Once each part is fully described in terms of such locally planar waves (modeled using a simple planar wave synthesis), the individual results can then be combined together using a general composite synthesis technique, based on scattering matrices and wave transformation. The example methods provide an efficient and rigorous framework to incorporate complex incoming and outgoing waves in a planar modeling framework. This can be incorporated into a planar moment-method modeling approach, with only minimal additional computation. This opens up new ways to manipulate composite waves and radiation. The example methods may be modified thereby opening new possibilities, as listed above, in modeling and design of modern radio-frequency communication circuits, antennas and systems, as well as any general electrical or electromagnetic device or system.

What is claimed is:

1. A computer implemented method for modeling or designing a structure including one or more planar elements arranged in association with one or more non-planar elements, the computer-implemented method comprising:
a) modeling, by a system including at least one computer processor, each of the one or more planar elements using both (i) conventional space-spectral analysis and (ii) complex space-spectral analysis to obtain an electro-magnetic (EM) signature matrix for each of the one or more planar elements;
b) determining, by the system, an EM signature matrix, compatible with those matrices of the one or more planar elements, for each of the one or more non-planar elements; and
c) combining, by the system, the EM signatures of each of the one or more planar elements and each of the one or more non-planar elements using matrix analysis to obtain a complete EM signature the structure,
wherein each of the one or more planar elements is (A) a planar antenna, or (B) a planar radio frequency circuit.

2. The computer-implemented method of claim 1 wherein the act of modeling each of the one or more planar elements using conventional space-spectral analysis to obtain an electro-magnetic (EM) signature matrix for each of the one or more planar elements includes using a moment model implemented in the spatial Fourier domain, and a complex-Fourier plane treatment of the moment model to extract EM signature information.

3. The computer-implemented method of claim 1 wherein for non-radiating elements, the act of modeling each of the one or more planar elements to obtain an electro-magnetic (EM) signature matrix for each of the one or more planar elements includes
i) locating a set of additional complex poles away from the real axis, and
ii) evaluating residue contributions of the located additional complex poles.

4. The computer-implemented method of claim 3 wherein the act of modeling each of the one or more planar elements to obtain an electro-magnetic (EM) signature matrix for each of the one or more non-radiating planar elements further includes
iii) at each of the real and additional complex poles, harmonically decomposing, into discrete parts, the respective one-dimensional residue integrands over the polar spectral variable.

5. The computer-implemented method of claim 1 wherein for radiating elements, the act of modeling each of the one or more planar elements to obtain an electro-magnetic (EM) signature matrix for each of the one or more planar elements includes
i) extending a branch cut along the real axis into the complex plane along the positive and negative imaginary axes, and
ii) evaluating the odd and even parts around the branch cut.

6. The computer-implemented method of claim 5 wherein the act of modeling each of the one or more planar elements to obtain an electro-magnetic (EM) signature matrix for each of the one or more radiating planar elements further includes
iii) at each of the complex branch cuts, harmonically decomposing, into discrete parts, the respective one-dimensional branch cut integrands over the polar spectral variable.

7. The computer-implemented method of claim 1 wherein the act of determining an EM signature matrix for at least one of the one or more non-planar elements uses a brute force modeling based on Maxwell's equations, and extracts an EM signature matrix, compatible with the EM signature matrices of the one or more planar elements, from the brute-force model.

8. The computer-implemented method of claim 1 wherein the act of determining an EM signature matrix for at least one of the one or more non-planar elements uses experimentally measured parameters.

9. The computer-implemented method of claim 1 wherein the act of determining an EM signature matrix for at least one of the one or more non-planar elements includes reading a previously determined EM signature matrix from a library of EM signature matrices stored on a non-transistory storage medium.

10. The computer-implemented method of claim 1 wherein the EM signature matrix for each of the one or more non-planar elements includes at least one of (A) reflection characteristics and (B) scattering or transmission characteristics.

11. The computer-implemented method of claim 1 wherein each of the EM signature matrices is expressed in terms of at least one of (A) planar, (B) cylindrical or (C) spherical waves, propagating in lateral and/or normal directions.

12. The computer-implemented method of claim 1 wherein the act of combining the EM signatures of each of the one or more planar elements and each of the one or more non-planar elements using matrix analysis to obtain a complete EM signature of the structure includes using mathematical contour deformation techniques on a complex Fourier plane.

13. The computer implemented method of claim 1 further comprising:
d) receiving, by the system, an input to rearrange at least one of the one or more planar elements or the one or more non-planar elements;
e) transforming, by the system, the EM signature of the rearranged element; and
f) recombining, using the system, the EM signatures of each of the one or more planar elements and each of the one or more non-planar elements using matrix analysis to obtain an updated complete EM signature of the structure.

14. The computer-implemented method of claim 1 wherein one of the one or more non-planar elements is (A) a non-planar packaging, (B) a non-planar scattering element, (C) a complex meta material, or (D) a periodic array element, and
wherein the act of determining an EM signature matrix for the one non-planar element includes modeling locally planar portions of the one non-planar element using both (i) the conventional space-spectral analysis and (ii) the complex space-spectral analysis.

15. Apparatus for modeling or designing a structure including one or more planar elements arranged in association with one or more non-planar elements, the apparatus comprising:
a) at least one processor; and
b) at least one non-transitory storage device storing processor-executable instructions which, when executed by the at least one processor, cause the at least one processor to perform a method including
1) modeling each of the one or more planar elements using both (i) conventional space-spectral analysis and (ii) complex space-spectral analysis to obtain an electro-magnetic (EM) signature matrix for each of the one or more planar elements,
2) determining an EM signature matrix, compatible with those matrices of the one or more planar elements, for each of the one or more non-planar elements, and
3) combining the EM signatures of each of the one or more planar elements and each of the one or more non-planar elements using matrix analysis to obtain a complete EM signature the structure,
wherein each of the one or more planar elements is (A) a planar antenna, or (B) a planar radio frequency circuit.

16. The apparatus of claim 15 wherein the act of modeling each of the one or more planar elements using conventional space-spectral analysis to obtain an electro-magnetic (EM) signature matrix for each of the one or more planar elements includes using a moment model implemented in the spatial Fourier domain, and a complex-Fourier plane treatment of the moment model to extract EM signature information.

17. The apparatus of claim 15 wherein for non-radiating elements, the act of modeling each of the one or more planar elements to obtain an electro-magnetic (EM) signature matrix for each of the one or more planar elements includes
locating a set of additional complex poles away from the real axis,
evaluating residue contributions of the located additional complex poles, and
at each of the real and additional complex poles, harmonically decomposing, into discrete parts, the respective one-dimensional residue integrands over the polar spectral variable.

18. The apparatus of claim 15 wherein for radiating elements, the act of modeling each of the one or more planar elements to obtain an electro-magnetic (EM) signature matrix for each of the one or more planar elements includes
extending a branch cut along the real axis into the complex plane along the positive and negative imaginary axes,
evaluating the odd and even parts around the branch cut, and
at each of the complex branch cuts, harmonically decomposing, into discrete parts, the respective one-dimensional branch cut integrands over the polar spectral variable.

19. The apparatus of claim 15 wherein the act of combining the EM signatures of each of the one or more planar elements and each of the one or more non-planar elements using matrix analysis to obtain a complete EM signature of the structure includes using mathematical contour deformation techniques on a complex Fourier plane.

20. The apparatus of claim 15 wherein the method further includes
4) receiving an input to rearrange at least one of the one or more planar elements or the one or more non-planar elements,
5) transforming the EM signature of the rearranged element, and
6) recombining the EM signatures of each of the one or more planar elements and each of the one or more non-planar elements using matrix analysis to obtain an updated complete EM signature of the structure.

21. The apparatus of claim 15 wherein one of the one or more non-planar elements is (A) a non-planar packaging, (B) a non-planar scattering element, (C) a complex meta material, or (D) a periodic array element, and
wherein the act of determining an EM signature matrix for the one non-planar element includes modeling locally planar portions of the one non-planar element using both (i) the conventional space-spectral analysis and (ii) the complex space-spectral analysis.

22. At least one non-transitory storage medium storing processor-executedable instructions which, when executed by at least one processor, cause the at least one processor to perform a method for modeling or designing a structure including one or more planar elements arranged in association with one or more non-planar elements, the method including
1) modeling each of the one or more planar elements using both (i) conventional space-spectral analysis and (ii) complex space-spectral analysis to obtain an electro-magnetic (EM) signature matrix for each of the one or more planar elements,
2) determining an EM signature matrix, compatible with those matrices of the one or more planar elements, for each of the one or more non-planar elements, and
3) combining the EM signatures of each of the one or more planar elements and each of the one or more non-planar elements using matrix analysis to obtain a complete EM signature the structure, wherein each of the one or more planar elements is (A) a planar antenna, or (B) a planar radio frequency circuit.

23. The non-transitory storage medium of claim 22 wherein the act of modeling each of the one or more planar elements using conventional space-spectral analysis to obtain an electro-magnetic (EM) signature matrix for each of the one or more planar elements includes using a moment model implemented in the spatial Fourier domain, and a complex-Fourier plane treatment of the moment model to extract EM signature information.

24. The non-transitory storage medium of claim 22 wherein for non-radiating elements, the act of modeling each of the one or more planar elements to obtain an electro-magnetic (EM) signature matrix for each of the one or more planar elements includes
locating a set of additional complex poles away from the real axis,
evaluating residue contributions of the located additional complex poles, and
at each of the real and additional complex poles, harmonically decomposing, into discrete parts, the respective one-dimensional residue integrands over the polar spectral variable.

25. The non-transitory storage medium of claim 22 wherein for radiating elements, the act of modeling each of the one or more planar elements to obtain an electro-magnetic (EM) signature matrix for each of the one or more planar elements includes
extending a branch cut along the real axis into the complex plane along the positive and negative imaginary axes,
evaluating the odd and even parts around the branch cut, and
at each of the complex branch cuts, harmonically decomposing, into discrete parts, the respective one-dimensional branch cut integrands over the polar spectral variable.

26. The non-transitory storage medium of claim 22 wherein the act of combining the EM signatures of each of the one or more planar elements and each of the one or more non-planar elements using matrix analysis to obtain a complete EM signature of the structure includes using mathematical contour deformation techniques on a complex Fourier plane.

27. The non-transitory storage medium of claim 22 wherein the method further includes
4) receiving an input to rearrange at least one of the one or more planar elements or the one or more non-planar elements,
5) transforming the EM signature of the rearranged element, and
6) recombining the EM signatures of each of the one or more planar elements and each of the one or more non-planar elements using matrix analysis to obtain an updated complete EM signature of the structure.

28. The non-transitory storage medium of claim 22 wherein one of the one or more non-planar elements is (A) a non-planar packaging, (B) a non-planar scattering element, (C) a complex meta material, or (D) a periodic array element, and
wherein the act of determining an EM signature matrix for the one non-planar element includes modeling locally planar portions of the one non-planar element using both (i) the conventional space-spectral analysis and (ii) the complex space-spectral analysis.
